(19) United States
(12) Patent Application Publication
(10) Pub. No.: US 2022/0205719 A1
(43) Pub. Date: Jun. 30, 2022

(54) Ultrasonic Yarn Drying System

(71) Applicant: Ornek Makina Sanayi Ve Ticaret Anonim Sirketi, Sehitkamil (TR)

(72) Inventors: Orhan Ersurmeli, SEHITKAMIL (TR); Bahattin Dabaniyasti, SEHITKAMIL (TR); Kemal Dabaniyasti, SEHITKAMIL (TR)

(21) Appl. No.: 17/530,699

(22) Filed: Nov. 19, 2021

(30) Foreign Application Priority Data
Dec. 30, 2020 (TR) 2020/22396

(51) Int. Cl. F26B 5/02; F26B 13/14; D06B 13/00

(52) U.S. Cl. CPC F26B 5/02; D06B 13/00; F26B 13/14

(57) ABSTRACT

An ultrasonic drying method used in yarn dyeing and drying machine (200) for drying the washed and dyed wet yarns (300) in the process of dyeing one or more yarns at a desired length in one or more colors in the manufacture of products such as carpet, hand-knit, knitwear in the textile sector, and to an ultrasonic drying system (100) for performing this method, wherein the system contains an Ultrasonic booster (101) which creates sound waves to be transmitted over the wet yarn (300) bundle the excess water of which has been removed by the vacuum unit (209) to remove the water therein before the drying tunnel (210); a horn (103) which is positioned between the ultrasonic booster (101) and the wet yarn (300) to transfer the sound waves generated by the Ultrasonic booster (101) to the wet yarn (300) bundle.

### CROSS REFERENCE TO RELATED APPLICATION

This application takes priority from and claims the benefit of Turkish Patent Application 2020/22396 filed on Dec. 30, 2020, the contents of which are herein incorporated by reference.

### BACKGROUND OF THE INVENTION

### Field of the Invention

The invention relates to an Ultrasonic drying method developed for drying washed and dyed yarns with the Ultrasonic sound waves in the process of dyeing one or more yarns at a desired length in one or more colors during the manufacture of products such as carpet, hand-knit, knitwear in the textile sector, and an ultrasonic drying system using this method.

### Description of the Related Art

Textile is classified into three main branches including yarn weaving, fabric weaving and finishing, and each of them form a separate sector in itself. After spinning the fibers as a yarn, the process of dyeing before they become woven or knit fabrics is called yarn dyeing. Yarn dyeing is less costly compared to fibre or tops (rib) dyeing. Yarn dyeing can be performed in two different yarn forms. Firstly, the yarns are wound as a bobbin and dyed in this form, secondly the yarns are dyed in the form of a skein. Generally the first method of dyeing of the yarn wound onto the bobbin is preferred. In this application, the yarns are wound on pressurized cones or bushings made of metal or plastic. These cylindrical bobbins are uniform in diameter, such that they ensure a more even dyeing process.

After the dyeing process being applied today, the excess dye pigments on the yarns, which are not absorbed need to be washed away. This process directly affects the production quality. When the yarns sooked upon washing, they need to be dried and brought into a certain humidity level before they become a final product. At the same time, the maximum and minimum humidity values in the yarns are defined by the standards, and these values should not be exceeded. If the yarns are not within the standard humidity values before the final product is obtained, they are accepted as a defective product. Thus, the drying process after washing is essential. Drying process directly affects the quality, production rate and manufacturing cost.

In the currently applied methods, the yarns to be dried are firstly passed over an air vacuum unit, and water is tried to be removed therefrom as much as possible. Then, these yarns are passed through a hot air tunnel and the remaining water thereon is evaporated and removed. Especially quite long drying tunnels are used for drying yarns of a type with high water absorption, such as viscose, via this method. These drying tunnels have been developed to evaporate the water on the yarn to be dried by blowing the heated air on the yarns with the aid of a fan. The reason for an excessive energy consumption to heat the aforementioned drying tunnels is the use of longer tunnels for the removal of water and drying process especially in yarns with high water absorption. Consequently, the energy needed in this context is quite high, and this directly affects the manufacturing costs in a negative way. On the other hand, a certain period of time is required to evaporate the water on the yarn by heating. As the amount of water increases, the production rate decreases since the evaporation and removal of water by heating takes a long time. Thus, this method used determines the production rate. For these reasons, an effective drying means much more production.

While increasing the efficiency of dyeing process in yarn manufacturing, many studies have been carried out and new systems/methods have been developed, in order to reduce the manufacturing costs and rate of waste. One of these studies is the invention regarding the patent application no. CN106192270 (A) and titled “A single yarn dyeing method and system”. The invention relates to a single yarn dyeing method which includes the process steps of pretreating the yarn from a yarn cylinder for washing under an Ultrasonic wave condition; dyeing the yarn under an Ultrasonic wave condition after the removal of impurity; after dyeing, applying a process of color fixation to the yarn; after the color fixation process, drying the yarn, provided that the temperature is from 80 to 100° C.; after drying, determining the tension of the yarn and ultimately winding on a roll. The invention also provides a single yarn dyeing system corresponding to a single yarn dyeing method. According to a single yarn dyeing method provided by the invention, as the yarn is fed directly into a drying machine for drying after pretreatment, dyeing and color fixation, the cylinder releasing and dehydrating stages are saved, and all working procedures in the preparation process starting from a primary colored yarn to the dyed final product are continuously performed without any delay in the operation, compared to a present yarn dyeing method. The efficiency of a single yarn dyeing process is improved and the energy conservation is provided, by means of the invention.

Another study is the invention regarding the patent application no. TR 2019/14609 and titled “A method developed for the production of colored denim fabric after dyeing the warp yarns in various colors in an indigo warp dyeing machine”. The invention relates to a method developed for the production of a colored denim fabric by dyeing the warp yarns in various colors in an indigo warp dyeing machine usable in warp yarn dyeing process in the textile sector, characterized in that it includes a creel portion onto which the warp yarns are wound; a pretreatment portion, which comprises a first vessel, a second vessel and a third vessel, into which the warp yarns exiting from the creel portion are introduced; a dyeing portion, which includes a fourth vessel, a fifth vessel, a sixth vessel, a seventh vessel, an eighth vessel, a ninth vessel, a tenth vessel, an eleventh vessel, a twelfth vessel and a thirteenth vessel following the pretreatment portion; a washing portion, a third drying cylinders where the warp yarns exiting from the washing portion are dried, a sizing portion in which the warp yarns exiting from the third drying cylinder are sized, a fourth drying cylinders in which the sized warp yarns are dried, an accumulator portion to which the dried warp yarns are introduced, a beam winding portion onto which the warp yarns exiting from the accumulator portion are wound, as well as the process steps for drying the warp yarns exiting from the creel portion in the first drying cylinder after they washed in the pre-treatment portion, dyeing the dried warp yarns in the fourteenth vessel cold and dry at 250-300 degrees without passing (bypassing) the fourth vessel, the fifth vessel, the sixth vessel, the seventh vessel, the eighth vessel, the ninth vessel, the tenth vessel, the eleventh vessel, the twelfth vessel and the thirteenth vessel situated in the dyeing portion, and drying the warp yarns exiting from the fourteenth vessel in the second drying cylinders.

As the current studies generally focus on improving dyeing efficiency, they have no effect on solving the problems arising in the drying stage. Consequently, the need for eliminating the disadvantages present in the state of art and an efficient drying of the dyed and washed yarns and the incapability of present solutions made it essential to realize a development in the related technical field.

### SUMMARY OF THE INVENTION

The present invention relates to an Ultrasonic drying method developed for drying the washed and dyed yarns with the Ultrasonic sound waves in the process of dyeing one or more yarns at a desired length in one or more colors in the manufacture of products such as carpet, hand-knit, knitwear in the textile sector, and an ultrasonic drying system using this method, which fulfil the aforementioned needs, eliminate all the disadvantages and provide some additional advantages.

In the light of the state of the art, an object of the invention is to allow the undesired water on the yarns to be almost completely removed by performing the drying process using an Ultrasonic vibration is.

The object of the invention is to allow the yarns to have the desired humidity level through a shorter hot air tunnel by almost completely removing the undesired water on the yarn via an Ultrasonic drying system.

Another object of the invention is to shorten the processing time and to reduce the energy consumption by allowing the yarn to have the desired humidity level using a shorter air drying tunnel.

Another object of the invention is to reduce the cost and increase the production by allowing the use of a 80% shorter hot air drying tunnel than the present systems by means of an Ultrasonic drying system.

The structural and characteristic properties of the invention and all advantages thereof will be understood more clearly on the basis of the figures given below and the detailed explanation given by reference to these figures, therefore, the evaluation should be made by considering these figures and the detailed explanations thereof.

### BRIEF DESCRIPTION OF DRAWINGS

In order to clearly understand the embodiment of the present invention and the advantages thereof together with the additional elements, it should be evaluated with the figures described below.

FIG. 1 is a schematic overall view of a yarn dyeing and drying machine; and

FIG. 2 is a schematic overall view of an Ultrasonic drying system.

### REFERENCE LIST

100. Ultrasonic drying system
101. Ultrasonic Booster
102. Control panel
103. Horn
104. Inlet idler cylinder
105. Outlet idler cylinder
200. Yarn dyeing and drying machine
201. Creel
202. Drawing godet
203. Preevaporation
204. Dyeing unit
205. Spreader
206. Frieze unit
207. Fixing boiler
208. Washing unit
209. Vacuum unit
210. Drying tunnel
211. Cooling unit
212. Accumulator
213. Bobbin winder
300. Wet yarn
400. Dehydrated yarn
500. Water particles

### DETAILED DESCRIPTION OF THE SEVERAL EMBODIMENTS

In this detailed description, an Ultrasonic drying method developed for drying the washed and dyed wet yarns (300) with the Ultrasonic sound waves in the process of dyeing one or more yarns at a desired length in one or more colors in the manufacture of products such as carpet, hand-knit, knitwear in the textile sector, and an ultrasonic drying system (100) using this method are described merely as an example in a non-limiting way for better understanding of the subject.

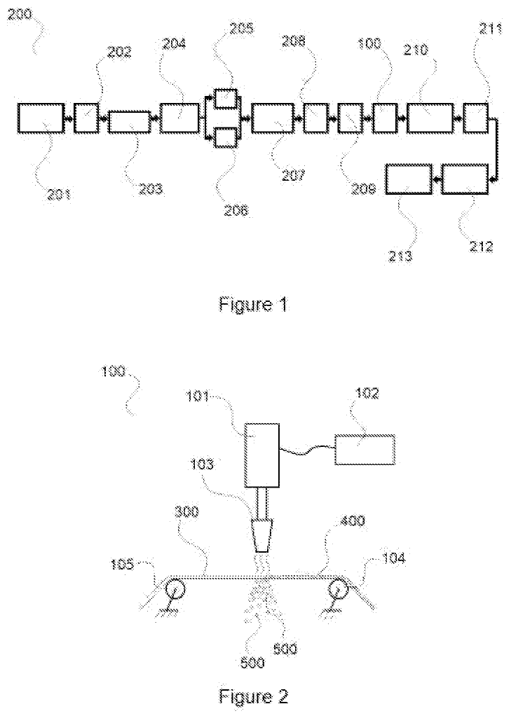

The Ultrasonic drying system (100) of the invention in which the water on the wet yarn (300) is removed via a vibration effect of high sound waves is an is used in the yarn dyeing and drying machines (200) which consist of a creel (201) to which the bobbins of the yarns is firstly attached for processing, a drawing godet (202) which draws the yarns from the creel (201) a preevaporation unit (203) which prepares the yarns for dyeing, a dyeing unit (204) which dyes the yarns in the desired color or pattern, a spreader (205) which spreads the yarns on the conveying belt in a ring form, a frieze unit (206) which transfers the yarns into the conveying belt after being crimped, a fixing boiler (207) (heat treating boiler) in which the yarns are subjected to a fixing process, a washing unit (208) in which the yarns are washed, a vacuum unit (209) in which the excess water of the yarns is removed, a drying tunnel (210) in which the humidity of the yarns are removed via hot air, a cooling unit (211) in which the yarns are cooled via a fan, an accumulator (212) where yarns are stored for later processing, and a bobbin winder (213) on which the yarns are rewound as a bobbin. Briefly, in the yarn dyeing and drying machines (200) shown in FIG. 1, the yarns are respectively drawn from the creel (201) by the drawing godet (202), and they are spread on the conveying belt by the spreader (205) and the frieze unit (206) after the yarns transferred to the dyeing unit (204) through the preevaporation unit (203) are dyed. Afterwards these yarns are introduced to the washing unit (208) by passing through the fixing boiler (207) on the conveying belt and are washed and subjected to a vacuuming process, respectively. The wet yarns (300) the excess water of which is removed via the vacuum unit (209) are passed through the Ultrasonic drying system (100), and the undesired water thereon is almost completely removed by means of a shaking effect of a high frequency Ultrasonic vibration. The dehydrated yarns (400) exiting from the Ultrasonic drying system (100) are passed through the drying tunnel (210). Since the water on the wet yarn (300) is almost completely removed by the Ultrasonic vibration, a 80% shorter drying tunnel (210) than the present applications may be used to provide the desired humidity level in the final product. Although this drying tunnel (210) length is shorter compared to those used in the present methods, much more effective drying process is obtained. So it is possible to provide more production by the Ultrasonic drying system (100) at a much lower cost. The yarns exiting from the drying tunnel (210) are passed through the cooling unit (211) and collected on the accumulator (212). Ultimately, the bobbin winder (213) winds the yarns here in the form of a bobbin and turns them into a final product.

In the aforementioned yarn dyeing and drying machine (200), the yarns in the form of bobbins attached to the creel (201) are drawn in a regular tension from the preevaporation unit (203) and dyeing unit (204) by the drafting godet (202). After the dyeing process, the yarns are spread by the spreader (205), or if the frieze (crimping) yarn is to be produced, the yarns are spread on the conveying belt by the frieze unit (206) (crimping) instead of the spreader (205). The yarns spread on the conveying belt are introduced to the washing unit (208) by passing through the fixing boiler (207) for the heat treatment. After the dyeing process, the washing process is performed in the washing unit (208) by water or a diluted cleaning agent in order to remove the undesired dyeing pigments or dyeing residual on the yarns. This washing process is realized by pressure injection, or by directly pouring the cleaning fluid thereon. After this process, the wet yarns (300) should be subjected to a drying process to maintain the production process and obtain the required humidity standards for the yarn production. The first step of this process is the absorption/vacuuming of the excess water on the wet yarns (300) as much as possible via a vacuum unit (209). Since the vacuuming method is insufficient to obtain the desired dryness depending on the desired production rate, a hot air drying tunnel (210) is used to decrease the humidity level of the yarns to an optimal extent. The Ultrasonic drying system (100) of the invention removes the water particles (500) present on the wet yarns (300) before the drying tunnel (210), while providing a more efficient drying operation in the shorter drying tunnels (210).

The Ultrasonic drying system (100) shown in FIG. 2 is positioned between the vacuum unit (209) and drying tunnel (210). In the ultrasonic drying system (100), the water on the wet yarns (300) exiting from the vacuum unit (209) and still having more humidity than desired is removed by the Ultrasonic sound waves. The aforementioned Ultrasonic drying system (100) removes the water on the wet yarns (300) in a ratio of 90% to 99%. This ratio may be different on the basis of the yarns that are processed. While this ratio is high in the yarns which have low absorption such as polyester, it may be rather low in the natural fibrous yarns which have a higher absorption such as viscose. Since the wetness of the wet yarns (300) is substantially removed by the Ultrasonic drying system (100), they may be passed through a drying tunnel (210) which may be rather shorter than those of the present methods in order to obtain the final humidity ratio. After the drying process, the dehydrated heated yarns (400) in the drying tunnel (210) are passed through the cooling unit (211) to decrease them to the ambient temperature. The yarns are cooled by blowing ambient air onto them. Afterwards, these yarns are pulled and accumulated by the accumulator (212). The line is provided to work continuously by this accumulation process. The yarns accumulated on the accumulator (212) are wound on the spools in the form of bobbins on the bobbin winder (213) to become a final product, and the production procedure is completed. The Ultrasonic booster (101) which forms the sound waves to be transmitted to the wet yarns (300) is situated on the upper part of the aforementioned Ultrasonic drying system (100). Said Ultrasonic booster (101) is connected to a control panel (102) to set the sound waves to be transmitted. A horn (103) positioned between said Ultrasonic booster (101) and the wet yarn (300) provides the transmission of the sound waves to the wet yarn (300) bundle. The inlet idler cylinder (104) positioned in the section where the wet yarns (300) are introduced to the aforementioned Ultrasonic drying system (100) cooperates with the outlet idler roller (105) positioned in the outlet portion of the dehydrated yarns (400) and keeps the yarn bundle stretched.

In the Ultrasonic drying method of the invention, the wet yarns (300) from the washing unit (208) are subjected to the vibration acquired by the high sound waves in the Ultrasonic system (100), and are dried by removing the water thereon by approximately 90% to 99%. The horn (103) to which the Ultrasonic booster (101) positioned in the Ultrasonic drying system (100) is connected and an adjustable control panel (102) (generator drive) thereof are used. In the Ultrasonic drying method the wet yarns (300) are passed through the Ultrasonic drying system (100) at a determined tautness via inlet idler roller (104) and outlet idler roller (105). The Ultrasonic sound waves generated by the Ultrasonic booster (101 are transmitted onto the wet yarn (300) bundle by the horn (103). The frequency of this sound wave is set by the control panel (102) on the basis of the yarn property. The water contained in the wet yarns (300) is removed by these sound waves in the form of water particles (500). The substantially dehydrated yarns (400) are transmitted to the drying tunnel (210) from the Ultrasonic drying system (100). This process is carried out with a continuous yarn flow.

What is claimed is:

1. An Ultrasonic drying method used in the yarn dyeing and drying machine (200) for drying the washed and dyed wet yarns (300) in the process of dyeing one or more yarns at a desired length in one or more colors in the manufacture of products such as carpet, hand-knit, knitwear in the textile sector and an Ultrasonic drying system (100) for performing this method characterized by comprising;
an Ultrasonic booster (101) which creates sound waves to be transmitted onto the wet yarn (300) bundle, the excess water of which has been removed by the vacuum unit (209) to remove the water contained therein before the drying tunnel (210);
a horn (103) which is positioned between the Ultrasonic booster (101) and the wet yarn (300) to transfer the sound waves generated by the ultrasonic booster (101) to the wet yarn (300) bundle.

2. The Ultrasonic drying system (100) according to claim 1, characterized in that it is positioned between the vacuum unit (209) and the drying tunnel (210).

3. The Ultrasonic drying system (100) according to claim 1, characterized in that it includes a control panel (102) to which the Ultrasonic booster (101) is connected in order to set the frequency of the sound waves to be transmitted.

4. The Ultrasonic drying system (100) according to claim 1, characterized in that it includes an inlet idler cylinder (104) which cooperates with the outlet idler cylinder (105) to keep the yarn bundle stretched and is positioned in the section where the wet yarns (300) are introduced to the Ultrasonic drying system (100).

5. The Ultrasonic drying system (100) according to claim 1, characterized in that it includes an outlet idler cylinder (105), which cooperates with the inlet idler cylinder (104) to keep the yarn bundle stretched and is positioned in the section where the dehydrated yarns (400) exit from the Ultrasonic drying system (100).

6. The Ultrasonic drying method for drying the washed and dyed wet yarns (300) in the process of dyeing one or more yarns at a desired length in one or more colors in the manufacture of products such as carpet, hand-knit, knitwear in the textile sector characterized in that it includes a process step of subjecting the wet yarns (300) from the washing unit (208) to the vibration acquired by the high sound waves generated by the Ultrasonic booster (101) to remove the excess water thereon.

7. The Ultrasonic drying method according to claim 6, characterized in that it includes a process step of transferring the Ultrasonic sound waves generated by the Ultrasonic booster (101) on the wet yarn (300) bundle by the horn (103).

8. The Ultrasonic drying method according to claim 6, characterized in that it includes a process step of setting the frequency of the sound wave to be generated by the Ultrasonic booster (101) via the control panel (102) with regard to the yarn property.

9. The Ultrasonic drying method according to claim 6, characterized in that it includes a process step of passing the wet yarns (300) through the Ultrasonic drying system (100) at a determined stretch via the inlet idler cylinder (104) and the outlet idler cylinder (105).

10. The Ultrasonic drying method according to claim 6, characterized in that it includes a process step of transferring the dehydrated yarns (400) exiting from the Ultrasonic drying system (100) to the drying tunnel (210).
